(19) United States
(12) Patent Application Publication
(10) Pub. No.: US 2025/0155689 A1
(43) Pub. Date: May 15, 2025

(54) Wide-Angle Lens Assembly

(71) Applicant: Asia Optical Co., Inc., Taichung (TW)

(72) Inventor: Yan-Jie Syu, Taichung (TW)

(21) Appl. No.: 18/915,695

(22) Filed: Oct. 15, 2024

(30) Foreign Application Priority Data
Nov. 14, 2023 (CN) 202311514286.0

(51) Int. Cl. G02B 13/06; G02B 9/64; G02B 13/00

(52) U.S. Cl. CPC G02B 13/06; G02B 9/64; G02B 13/0045

(57) ABSTRACT

A wide-angle lens assembly includes a first lens, a second lens, a third lens, a fourth lens, a fifth lens, a sixth lens, a seventh lens, and an eighth lens, all of which are arranged in order from an object side to an image side along an optical axis. The first lens is with refractive power. The second lens is with refractive power. The third lens is with positive refractive power and includes a convex surface facing the image side. The fourth lens is with refractive power. The fifth lens is with positive refractive power and includes a convex surface facing the image side. The sixth lens is with refractive power. The seventh lens is with positive refractive power. The eighth lens is with refractive and includes a concave surface facing an object side.

### BACKGROUND OF THE INVENTION

### Field of the Invention

The present invention relates to a wide-angle lens assembly.

### Description of the Related Art

The current development trend of a wide-angle lens assembly is toward large field of view. Additionally, the wide-angle lens assembly is developed to have miniaturization, large stop, and high resolution in accordance with different application requirements. However, the known wide-angle lens assembly can't satisfy such requirements. Therefore, the wide-angle lens assembly needs a new structure in order to meet the requirements of large field of view, miniaturization, large stop, and high resolution at the same time.

### BRIEF SUMMARY OF THE INVENTION

The invention provides a wide-angle lens assembly to solve the above problems. The wide-angle lens assembly of the invention is provided with characteristics of an increased field of view, a decreased total lens length, a decreased F-number, an increased resolution, and still has a good optical performance.

The wide-angle lens assembly in accordance with an exemplary embodiment of the invention includes a first lens, a second lens, a third lens, a fourth lens, a fifth lens, a sixth lens, a seventh lens, and an eighth lens. The first lens is with refractive power. The second lens is with refractive power. The third lens is with positive refractive power and includes a convex surface facing an image side. The fourth lens is with refractive power. The fifth lens is with positive refractive power and includes a convex surface facing the image side. The sixth lens is with refractive power. The seventh lens is with positive refractive power. The eighth lens is with refractive and includes a concave surface facing an object side. The first lens, the second lens, the third lens, the fourth lens, the fifth lens, the sixth lens, the seventh lens, and the eighth lens are arranged in order from the object side to the image side along an optical axis. A wide-angle lens assembly of the present invention can achieve the basic function when the wide-angle lens assembly satisfies the above features and does not require other additional features or conditions.

In another exemplary embodiment, the first lens is with negative refractive power; the second lens is with positive refractive power; the fourth lens is with negative refractive power; the sixth lens is with positive refractive power; and the eighth lens is with negative refractive power.

In yet another exemplary embodiment, the first lens includes a concave surface facing the image side; the second lens includes a convex surface facing the object side; the third lens is a biconvex lens and further includes another convex surface facing the object side; and the eighth lens is a biconcave lens and further includes another concave surface facing the image side.

In another exemplary embodiment, the first lens is a meniscus lens and further includes a convex surface facing the object side; and the second lens is a meniscus lens and further includes a concave surface facing the image side.

In yet another exemplary embodiment, the wide-angle lens assembly satisfies at least one of the following conditions: −245≤Vd7/(f8/f4)≤27; −3 mm≤(R51−R22)/Vd7≤41 mm; −1.2 mm⁻1≤(Vd2−Vd6)/R22≤0.7 mm⁻¹; −17 mm≤R22/Vd2≤6.2 mm; −3.1 mm≤f8−f4≤7.8 mm; −7.29≤R32/T3≤−4.16; −2.24≤(R31+R32)/T3≤2.75; 4.92 mm≤T1+T2+T3≤7.95 mm; 14.32≤TTL/T12≤18.01; 18.23≤TTL/T34≤36.68; wherein f4 is an effective focal length of the fourth lens, f8 is an effective focal length of the eighth lens, Vd2 is an Abbe number of the second lens, Vd6 is an Abbe number of the sixth lens, Vd7 is an Abbe number of the seventh lens, TTL is an interval from an object side surface of the first lens to an image plane along the optical axis, R22 is a radius of curvature of an image side surface of the second lens, R31 is a radius of curvature of an object side surface of the third lens, R32 is a radius of curvature of an image side surface of the third lens, R51 is a radius of curvature of an object side surface of the fifth lens, T12 is an air interval from an image side surface of the first lens to an object side surface of the second lens along the optical axis, T34 is an air interval from the image side surface of the third lens to an object side surface of the fourth lens along the optical axis, T1 is an interval from the object side surface of the first lens to the image side surface of the first lens along the optical axis, T2 is an interval from the object side surface of the second lens to the image side surface of the second lens along the optical axis, and T3 is an interval from the object side surface of the third lens to the image side surface of the third lens along the optical axis.

In another exemplary embodiment, the first lens is a meniscus lens and further includes a convex surface facing the object side; and the second lens is a biconvex lens and further includes another convex surface facing the image side.

In yet another exemplary embodiment, the first lens is a biconcave lens and further includes another concave surface facing the object side; and the second lens is a meniscus lens and further includes a concave surface facing the image side.

In another exemplary embodiment, the fourth lens is a biconcave lens and includes a concave surface facing the object side and another concave surface facing the image side; the sixth lens is a biconvex lens and includes a convex surface facing the object side and another convex surface facing the image side; and the seventh lens is a biconvex lens and includes a convex surface facing the object side and another convex surface facing the image side.

In yet another exemplary embodiment, the fifth lens is a biconvex lens and further includes another convex surface facing the object side.

In another exemplary embodiment, the fifth lens is a meniscus lens and further includes a concave surface facing the object side.

In yet another exemplary embodiment, the first lens is a meniscus lens with negative refractive power and includes a convex surface facing the object side and a concave surface facing the image side; the second lens is a meniscus lens with positive refractive power and includes a convex surface facing the object side and a concave surface facing the image side; the third lens is a biconvex lens and further includes another convex surface facing the object side; the fourth lens is a biconcave lens with negative refractive power and includes a concave surface facing the object side and another concave surface facing the image side; the fifth lens is a biconvex lens and further includes another convex surface facing the object side; the sixth lens is a biconvex lens with positive refractive power and includes a convex surface facing the object side and another convex surface facing the image side; the seventh lens is a biconvex lens and includes a convex surface facing the object side and another convex surface facing the image side; and the eighth lens is a biconcave lens with negative refractive power and further includes another concave surface facing the image side.

In another exemplary embodiment, the first lens is a meniscus lens with negative refractive power and includes a convex surface facing the object side and a concave surface facing the image side; the second lens is a meniscus lens with positive refractive power and includes a convex surface facing the object side and a concave surface facing the image side; the third lens is a biconvex lens and further includes another convex surface facing the object side; the fourth lens is a biconcave lens with negative refractive power and includes a concave surface facing the object side and another concave surface facing the image side; the fifth lens is a meniscus lens and further includes a concave surface facing the object side; the sixth lens is a biconvex lens with positive refractive power and includes a convex surface facing the object side and another convex surface facing the image side; the seventh lens is a biconvex lens and includes a convex surface facing the object side and another convex surface facing the image side; and the eighth lens is a biconcave lens with negative refractive power and further includes another concave surface facing the image side.

In yet another exemplary embodiment, the first lens is a meniscus lens with negative refractive power and includes a convex surface facing the object side and a concave surface facing the image side; the second lens is a biconvex lens with positive refractive power and includes a convex surface facing the object side and another convex surface facing the image side; the third lens is a biconvex lens and further includes another convex surface facing the object side; the fourth lens is a biconcave lens with negative refractive power and includes a concave surface facing the object side and another concave surface facing the image side; the fifth lens is a meniscus lens and further includes a concave surface facing the object side; the sixth lens is a biconvex lens with positive refractive power and includes a convex surface facing the object side and another convex surface facing the image side; the seventh lens is a biconvex lens and includes a convex surface facing the object side and another convex surface facing the image side; and the eighth lens is a biconcave lens with negative refractive power and further includes another concave surface facing the image side.

In another exemplary embodiment, the first lens is a meniscus lens with negative refractive power and includes a convex surface facing the object side and a concave surface facing the image side; the second lens is a biconvex lens with positive refractive power and includes a convex surface facing the object side and another convex surface facing the image side; the third lens is a biconvex lens and further includes another convex surface facing the object side; the fourth lens is a biconcave lens with negative refractive power and includes a concave surface facing the object side and another concave surface facing the image side; the fifth lens is a biconvex lens and further includes another convex surface facing the object side; the sixth lens is a biconvex lens with positive refractive power and includes a convex surface facing the object side and another convex surface facing the image side; the seventh lens is a biconvex lens and includes a convex surface facing the object side and another convex surface facing the image side; and the eighth lens is a biconcave lens with negative refractive power and further includes another concave surface facing the image side.

In yet another exemplary embodiment, the first lens is a biconcave lens with negative refractive power and includes a concave surface facing the object side and another concave surface facing the image side; the second lens is a meniscus lens with positive refractive power and includes a convex surface facing the object side and a concave surface facing the image side; the third lens is a biconvex lens and further includes another convex surface facing the object side; the fourth lens is a biconcave lens with negative refractive power and includes a concave surface facing the object side and another concave surface facing the image side; the fifth lens is a meniscus lens and further includes a concave surface facing the object side; the sixth lens is a biconvex lens with positive refractive power and includes a convex surface facing the object side and another convex surface facing the image side; the seventh lens is a biconvex lens and includes a convex surface facing the object side and another convex surface facing the image side; and the eighth lens is a biconcave lens with negative refractive power and further includes another concave surface facing the image side.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a lens layout and optical path diagram of a wide-angle lens assembly in accordance with a first embodiment of the invention;

FIGS. 2, 3, 4 depict a longitudinal aberration diagram, a field curvature diagram, and a distortion diagram of the wide-angle lens assembly in accordance with the first embodiment of the invention, respectively;

FIG. 5 is a lens layout and optical path diagram of a wide-angle lens assembly in accordance with a second embodiment of the invention;

FIGS. 6, 7, 8 depict a longitudinal aberration diagram, a field curvature diagram, and a distortion diagram of the wide-angle lens assembly in accordance with the second embodiment of the invention, respectively;

FIG. 9 is a lens layout and optical path diagram of a wide-angle lens assembly in accordance with a third embodiment of the invention;

FIGS. 10, 11, 12 depict a longitudinal aberration diagram, a field curvature diagram, and a distortion diagram of the wide-angle lens assembly in accordance with the third embodiment of the invention, respectively;

FIG. 13 is a lens layout and optical path diagram of a wide-angle lens assembly in accordance with a fourth embodiment of the invention; and

FIG. 14 is a lens layout and optical path diagram of a wide-angle lens assembly in accordance with a fifth embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides a wide-angle lens assembly including a first lens, a second lens, a third lens, a fourth lens, a fifth lens, a sixth lens, a seventh lens, and an eighth lens. The first lens is with refractive power. The second lens is with refractive power. The third lens is with positive refractive power and includes a convex surface facing an image side. The fourth lens is with refractive power. The fifth lens is with positive refractive power and includes a convex surface facing the image side. The sixth lens is with refractive power. The seventh lens is with positive refractive power. The eighth lens is with refractive power and includes a concave surface facing an object side. The first lens, the second lens, the third lens, the fourth lens, the fifth lens, the sixth lens, the seventh lens, and the eighth lens are arranged in order from the object side to the image side along an optical axis. A lens assembly of the present invention is a preferred embodiment of the present invention when the lens assembly satisfies the above features.

Referring to Table 1, Table 2, Table 4, Table 5, Table 7, Table 8, Table 10,Table 11, Table 13, and Table 14, wherein Table 1, Table 4, Table 7, Table 10, and Table 13 show optical specification in accordance with a first, a second, a third, a fourth, and a fifth embodiments of the invention, respectively, and Table 2, Table 5, Table 8, Table 11, and Table 14 show aspheric coefficients of each aspheric lens in Table 1, Table 4, Table 7, Table 10, and Table 13, respectively. The aspheric surface sag z of each aspheric lens in the following embodiments can be calculated by the following formula: z=ch²/{1+[1−(k+1)c²h²]^{1/2}}+Ah⁴+Bh⁶+Ch⁸+Dh¹⁰, where c is curvature, h is the vertical distance from the lens surface to the optical axis, k is conic constant, A, B, C, and D are aspheric coefficients, and the values of the aspheric coefficients A, B, C, and D are presented in scientific notation, such as 2.00E-03 for 2.00×10⁻³.

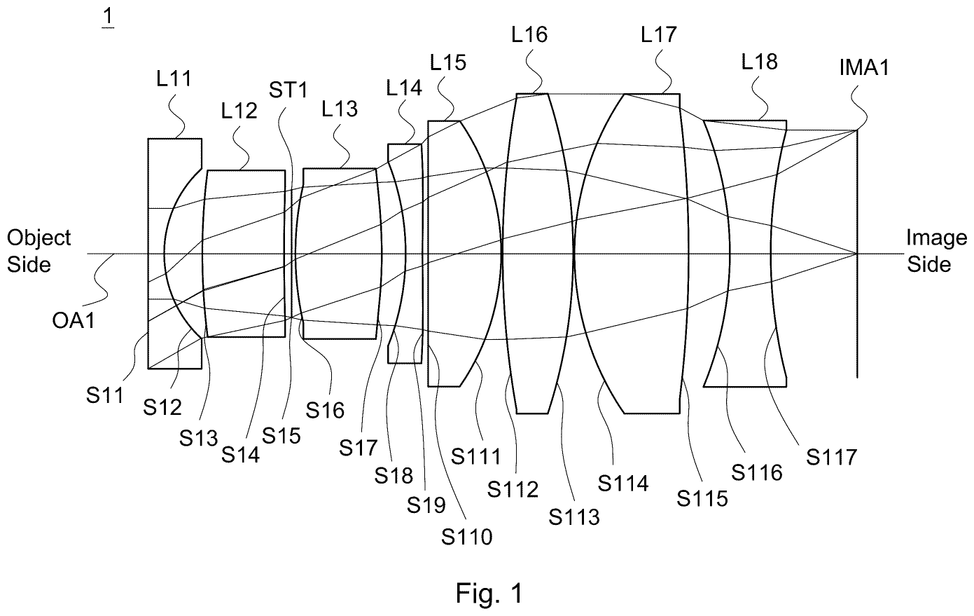

FIGS. 1, 5, 9, 13, and 14 are lens layout and optical path diagrams of the lens assemblies in accordance with the first, second, third, fourth, and fifth embodiments of the invention, respectively.

The first lenses L11, L21, L31, L41, L51 are with negative refractive power, wherein the image side surfaces S12, S22, S32, S42, S52 are concave surfaces and both of the object side surfaces S11, S21, S31, S41, S51 and image side surfaces S12, S22, S32, S42, S52 are spherical surfaces.

The second lenses L12, L22, L32, L42, L52 are with positive refractive power, wherein the object side surfaces S13, S23, S33, S43, S53 are convex surfaces and both of the object side surfaces S13, S23, S33, S43, S53 and image side surfaces S14, S24, S34, S44, S54 are spherical surfaces.

The third lenses L13, L23, L33, L43, L53 are biconvex lenses with positive refractive power, wherein the object side surfaces S16, S26, S36, S46, S56 are convex surfaces, the image side surfaces S17, S27, S37, S47, S57 are convex surfaces, and both of the object side surfaces S16, S26, S36, S46, S56 and image side surfaces S17, S27, S37, S47, S57 are aspheric surfaces.

The fourth lenses L14, L24, L34, L44, L54 are biconcave lenses with negative refractive power, wherein the object side surfaces S18, S28, S38, S48, S58 are concave surfaces, the image side surfaces S19 S29, S39, S49, S59 are concave surfaces, and both of the object side surfaces S18, S28, S38, S48, S58 and image side surfaces S19 S29, S39, S49, S59 are spherical surfaces.

The fifth lenses L15, L25, L35, L45, L55 are with positive refractive power, wherein the image side surfaces S111, S211, S311, S411, S511 are convex surfaces and both of the object side surfaces S110, S210, S310, S410, S510 and image side surfaces S111, S211, S311, S411, S511 are spherical surfaces.

The sixth lenses L16, L26, L36, L46, L56 are biconvex lenses with positive refractive power, wherein the object side surfaces S112, S212, S312, S412, S512 are convex surfaces, the image side surfaces S113 S213, S313, S413, S513 are convex surfaces, and both of the object side surfaces S112, S212, S312, S412, S512 and image side surfaces S113 S213, S313, S413, S513 are aspheric surfaces.

The seventh lenses L17, L27, L37, L47, L57 are biconvex lenses with positive refractive power, wherein the object side surfaces S114, S214, S314, S414, S514 are convex surfaces, the image side surfaces S115, S215, S315, S415, S515 are convex surfaces, and both of the object side surfaces S114, S214, S314, S414, S514 and image side surfaces S115, S215, S315, S415, S515 are spherical surfaces.

The eighth lenses L18, L28, L38, L48, L58 are biconcave lenses with negative refractive power, wherein the object side surfaces S116, S216, S316, S416, S516 are concave surfaces, the image side surfaces S117 S217, S317, S417, S517 are concave surfaces, and both of the object side surfaces S116, S216, S316, S416, S516 and image side surfaces S117 S217, S317, S417, S517 are aspheric surfaces.

In addition, the wide-angle lens assemblies 1, 2, 3, 4, and 5 satisfy at least one of the following conditions (1)-(10):

$$- 245 \leq Vd 7 / ( f 8 / f 4 ) \leq 27 ; \qquad ( 1 )$$

$$- 3 mm \leq ( R 51 - R 22 ) / Vd 7 \leq 41 mm ; \qquad ( 2 )$$

$$- 1.2 {mm}^{- 1} \leq ( Vd 2 - Vd 6 ) / R 22 \leq 0.7 {mm}^{- 1} ; \qquad ( 3 )$$

$$- 17 mm \leq R 22 / Vd 2 \leq 6.2 mm ; \qquad ( 4 )$$

$$- 3.1 mm \leq f 8 - f 4 \leq 7.8 mm ; \qquad ( 5 )$$

$$- 7.29 \leq R 32 / T 3 \leq - 4 \text{.16} ; \qquad ( 6 )$$

$$- 2.24 \leq ( R 31 + R 32 ) / T 3 \leq 2 \text{.75} ; \qquad ( 7 )$$

$$4.92 mm \leq T 1 + T 2 + T 3 \leq 7.95 mm ; \qquad ( 8 )$$

$$14.32 \leq TTL / T 12 \leq 18 \text{.01} ; \qquad ( 9 )$$

$$18.23 \leq TTL / T 34 \leq 36 \text{.68} ; \qquad ( 10 )$$

wherein: f4 is an effective focal length of the fourth lenses L14, L24, L34, L44, L54 for the first to fifth embodiments; f8 is an effective focal length of the eighth lenses L18, L28, L38, L48, L58 for the first to fifth embodiments; Vd2 is an Abbe number of the second lenses L12, L22, L32, L42, L52 for the first to fifth embodiments; Vd6 is an Abbe number of the sixth lenses L16, L26, L36, L46, L56 for the first to fifth embodiments; Vd7 is an Abbe number of the seventh lenses L17, L27, L37, L47, L57 for the first to fifth embodiments; TTL is an interval from the object side surfaces S11, S21, S31, S41, S51 of the first lenses L11, L21, L31, L41, L51 to the image planes IMA1, IMA2, IMA3, IMA4, IMA5 along the optical axes OA1, OA2, OA3, OA4, OA5 for the first to fifth embodiments; R22 is a radius of curvature of the image side surfaces S14, S24, S34, S44, S54 of the second lenses L12, L22, L32, L42, L52 for the first to fifth embodiments; R31 is a radius of curvature of the object side surfaces S16, S26, S36, S46, S56 of the third lenses L13, L23, L33, L43, L53 for the first to fifth embodiments; R32 is a radius of curvature of the image side surfaces S17, S27, S37, S47, S57 of the third lenses L13, L23, L33, L43, L53 for the first to fifth embodiments; R51 is a radius of curvature of the object side surfaces S110, S210, S310, S410, S510 of the fifth lenses L15, L25, L35, L45, L55 for the first to fifth embodiments; T12 is an air interval from the image side surfaces S12, S22, S32, S42, S52 of the first lenses L11, L21, L31, L41, L51 to the object side surfaces S13, S23, S33, S43, S53 of the second lenses L12, L22, L32, L42, L52 along the optical axes OA1, OA2, OA3, OA4, OA5 for the first to fifth embodiments; T34 is an air interval from the image side surfaces S17, S27, S37, S47, S57 of the third lenses L13, L23, L33, L43, L53 to the object side surfaces S18, S28, S38, S48, S58 of the fourth lenses L14, L24, L34, L44, L54 along the optical axes OA1, OA2, OA3, OA4, OA5 for the first to fifth embodiments; T1 is an interval from the object side surfaces S11, S21, S31, S41, S51 of the first lenses L11, L21, L31, L41, L51 to the image side surfaces S12, S22, S32, S42, S52 of the first lenses L11, L21, L31, L41, L51 along the optical axes OA1, OA2, OA3, OA4, OA5 for the first to fifth embodiments; T2 is an interval from the object side surfaces S13, S23, S33, S43, S53 of the second lenses L12, L22, L32, L42, L52 to the image side surfaces S14, S24, S34, S44, S54 of the second lenses L12, L22, L32, L42, L52 along the optical axes OA1, OA2, OA3, OA4, OA5 for the first to fifth embodiments; and T3 is an interval from the object side surfaces S16, S26, S36, S46, S56 of the third lenses L13, L23, L33, L43, L53 to the image side surfaces S17, S27, S37, S47, S57 of the third lenses L13, L23, L33, L43, L53 along the optical axes OA1, OA2, OA3, OA4, OA5 for the first to fifth embodiments. With the wide-angle lens assemblies 1, 2, 3, 4, 5 satisfying at least one of the above conditions (1)-(10), the total lens length can be effectively decreased, the F-number can be effectively decreased, the resolution can be effectively increased, and the aberration can be effectively corrected.

When the condition (3): −1.2 mm⁻¹≤(Vd2−Vd6)/R22≤0.7 mm⁻¹ is satisfied, the chromatic aberration can be effectively decreased. When the condition (4): −17 mm≤R22/Vd2≤6.2 mm is satisfied, the chromatic aberration can be effectively decreased. When the condition (5): −3.1 mm≤f8−f4≤7.8 mm is satisfied, the manufacturing yield rate of the lens can be effectively increased and the volume of the wide-angle lens assembly can be effectively decreased. When the condition (6): −7.29≤R32/T3≤−4.16 is satisfied, the manufacturing yield rate of the lens can be effectively increased and the volume of the wide-angle lens assembly can be effectively decreased. When the condition (7): −2.24≤(R31+R32)/T3≤2.75 is satisfied, the manufacturing yield rate of the lens can be effectively increased and the volume of the wide-angle lens assembly can be effectively decreased. When the condition (8): 4.92 mm≤T1+T2+T3≤7.95 mm is satisfied, the manufacturing yield rate of the lens can be effectively increased and the volume of the wide-angle lens assembly can be effectively decreased. When the condition (9): 14.32≤TTL/T12≤18.01 is satisfied, the manufacturing yield rate of the lens can be effectively increased and the volume of the wide-angle lens assembly can be effectively decreased. When the condition (10): 18.23≤TTL/T34≤36.68 is satisfied, the manufacturing yield rate of the lens can be effectively increased and the volume of the wide-angle lens assembly can be effectively decreased.

A detailed description of a wide-angle lens assembly in accordance with a first embodiment of the invention is as follows. Referring to FIG. 1, the wide-angle lens assembly 1 includes a first lens L11, a second lens L12, a stop ST1, a third lens L13, a fourth lens L14, a fifth lens L15, a sixth lens L16, a seventh lens L17, and an eighth lens L18, all of which are arranged in order from an object side to an image side along an optical axis OA1. In operation, the light from the object side is imaged on an image plane IMA1.

According to the foregoing, wherein: the first lens L11 is a meniscus lens, wherein the object side surface S11 is a convex surface; the second lens L12 is a meniscus lens, wherein the image side surface S14 is a concave surface; the fifth lens L15 is a biconvex lens, wherein the object side surface S110 is a convex surface; with the above design of the lenses, stop ST1, and at least one of the conditions (1)-(10) satisfied, the wide-angle lens assembly 1 can have an effective decreased total lens length, an effective decreased F-number, an effective increased resolution, and an effective corrected aberration. The wide-angle lens assembly of the present invention can meet the basic operation requirements when it only satisfies conditions (1), (2), or (5), and the refractive surface shape characteristics of the independent claim.

Table 1 shows the optical specification of the wide-angle lens assembly 1 in FIG. 1.

TABLE 1
Effective Focal Length = 6.231 mm F-number = 1.642
Total Lens Length = 25.84 mm Field of View = 101.7 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S11 | 1302.57 | 0.70 | 1.62 | 60 | −7.782 | L11 |
| S12 | 4.82 | 1.60 | | | | |
| S13 | 27.16 | 3.46 | 2.00 | 17 | 35.987 | L12 |
| S14 | 100.34 | 0.32 | | | | |
| S15 | ∞ | 0.16 | | | | ST1 |
| S16 | 14.01 | 3.65 | 1.50 | 60 | 16.700 | L13 |
| S17 | −19.01 | 1.00 | | | | |
| S18 | −12.29 | 0.72 | 1.66 | 20 | −16.038 | L14 |
| S19 | 83.48 | 0.24 | | | | |
| S110 | 2948.55 | 3.10 | 1.60 | 70 | 16.029 | L15 |
| S111 | −9.67 | 0.06 | | | | |
| S112 | 37.29 | 2.98 | 1.73 | 55 | 19.002 | L16 |
| S113 | −21.46 | 0.06 | | | | |
| S114 | 11.72 | 4.83 | 1.60 | 70 | 16.187 | L17 |
| S115 | −48.58 | 1.75 | | | | |
| S116 | −15.80 | 1.74 | 1.60 | 24 | −16.325 | L18 |
| S117 | 27.38 | 2.17 | | | | |

In the first embodiment, the conic constant k and the aspheric coefficients A, B, C, D of each aspheric lens are shown in Table 2.

TABLE 2

| Surface | | | | | |
|---|---|---|---|---|---|
| Number | k | A | B | C | D |
| S16 | −3.50E+00 | 5.11E−04 | 1.51E−05 | −1.24E−06 | 1.02E−07 |
| S17 | −8.13E+01 | −6.36E−04 | 6.67E−05 | −3.56E−06 | 1.06E−07 |
| S112 | 5.62E+00 | 1.15E−04 | −1.66E−05 | 8.50E−07 | 1.62E−08 |
| S113 | −8.09E−01 | −5.27E−04 | 2.43E−06 | 3.98E−07 | −8.81E−09 |
| S116 | 1.03E+00 | −3.20E−04 | 1.03E−05 | −8.75E−08 | 0.00E+00 |
| S117 | 0.00E+00 | 7.73E−05 | 4.52E−06 | 3.82E−08 | −1.94E−09 |

Table 3 shows the parameters and condition values for conditions (1)-(10) in accordance with the first embodiment of the invention. It can be seen from Table 3 that the wide-angle lens assembly 1 of the first embodiment satisfies the conditions (1)-(10).

TABLE 3

| T1 | 0.70 mm | T2 | 3.46 | mm | T3 | 3.65 | mm |
|---|---|---|---|---|---|---|---|
| T12 | 1.60 mm | T34 | 1.00 | mm | | | |
| Vd7/(f8/f4) | −243.90 | (R51 − R22)/Vd7 | 40.69 | mm | (Vd2 − Vd6)/R22 | −0.38 | mm⁻¹ |

| | | | | | | |
|---|---|---|---|---|---|---|
| R22/Vd2 | 6.08 mm | f8 − f4 | −0.29 | mm | R32/T3 | −5.20 |
| (R31 + R32)/T3 | −1.37 | T1 + T2 + T3 | 7.81 | mm | TTL/T12 | 17.84 |

| | |
|---|---|
| TTL/T34 | 28.42 |

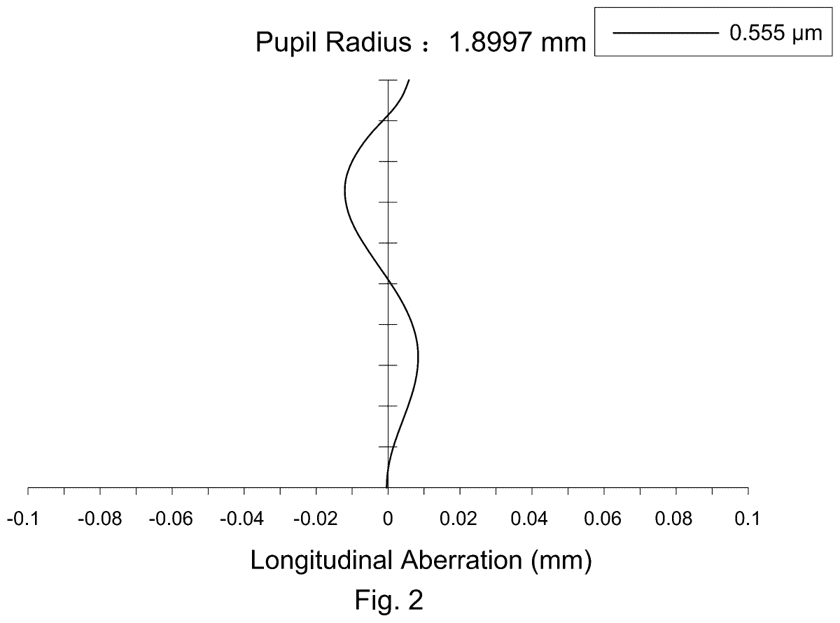

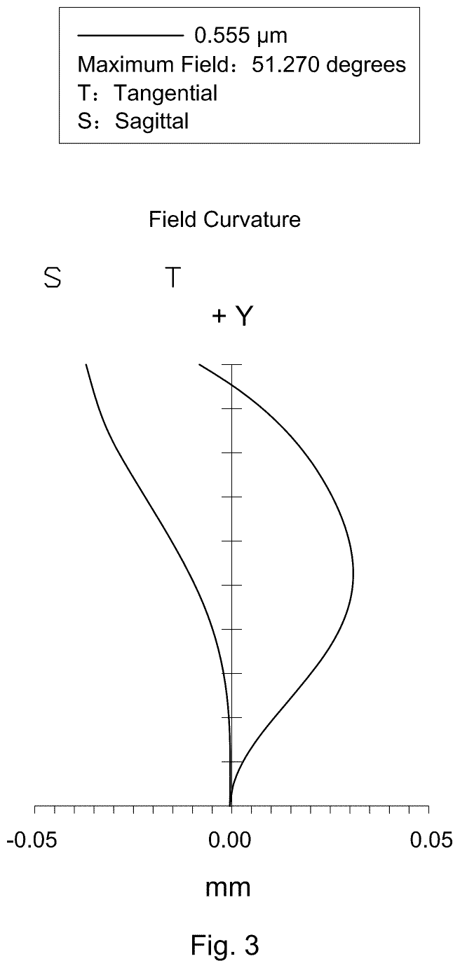

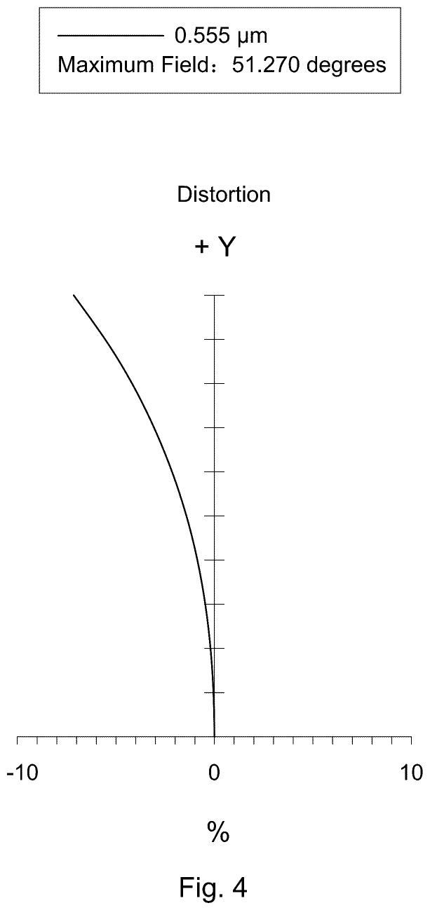

In addition, the wide-angle lens assembly 1 of the first embodiment can meet the requirements of optical performance as seen in FIGS. 2-4. It can be seen from FIG. 2 that the longitudinal aberration in the wide-angle lens assembly 1 of the first embodiment ranges from −0.02 mm to 0.01 mm. It can be seen from FIG. 3 that the field curvature of tangential direction and sagittal direction in the wide-angle lens assembly 1 of the first embodiment ranges from −0.04 mm to 0.035 mm. It can be seen from FIG. 4 that the distortion in the wide-angle lens assembly 1 of the first embodiment ranges from −7% to 0%. It is obvious that the longitudinal aberration, the field curvature, and the distortion of the wide-angle lens assembly 1 of the first embodiment can be corrected effectively. Therefore, the wide-angle lens assembly 1 of the first embodiment is capable of good optical performance.

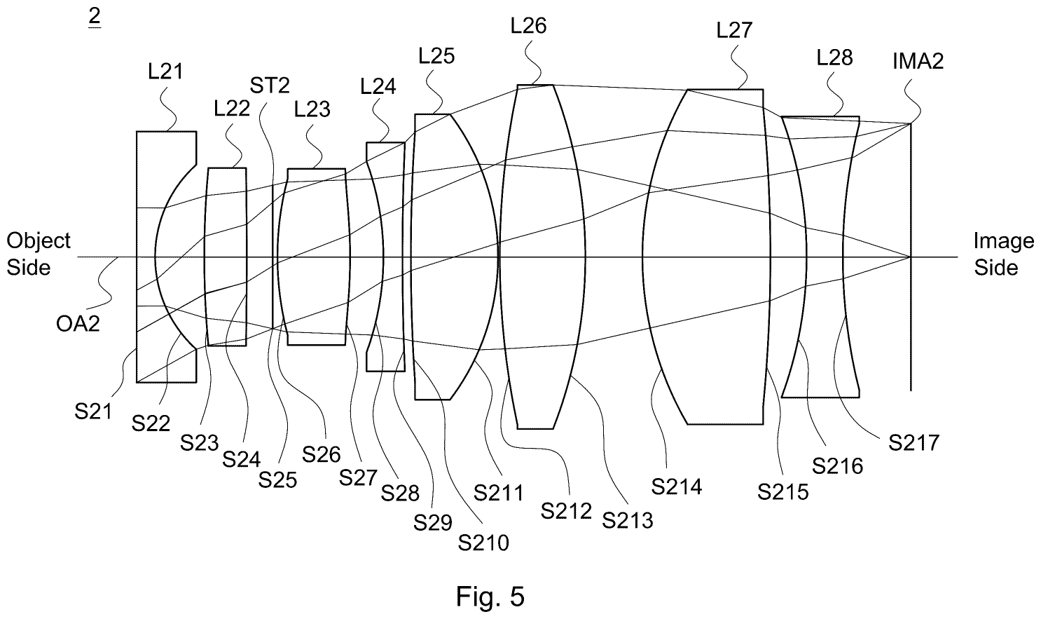

A detailed description of a wide-angle lens assembly in accordance with a second embodiment of the invention is as follows. Referring to FIG. 5, the wide-angle lens assembly 2 includes a first lens L21, a second lens L22, a stop ST2, a third lens L23, a fourth lens L24, a fifth lens L25, a sixth lens L26, a seventh lens L27, and an eighth lens L28, all of which are arranged in order from an object side to an image side along an optical axis OA2. In operation, the light from the object side is imaged on an image plane IMA2.

According to the foregoing, wherein: the first lens L21 is a meniscus lens, wherein the object side surface S21 is a convex surface; the second lens L22 is a biconvex lens, wherein the image side surface S24 is a convex surface; the fifth lens L25 is a biconvex lens, wherein the object side surface S210 is a convex surface; with the above design of the lenses, stop ST2, and at least one of the conditions (1)-(10) satisfied, the wide-angle lens assembly 2 can have an effective decreased total lens length, an effective decreased F-number, an effective increased resolution, and an effective corrected aberration. The wide-angle lens assembly of the present invention can meet the basic operation requirements when it only satisfies conditions (3) or (4), and the refractive surface shape characteristics of the independent claim.

Table 4 shows the optical specification of the wide-angle lens assembly 2 in FIG. 5.

TABLE 4
Effective Focal Length = 6.1986 mm F-number = 1.64
Total Lens Length = 30.00 mm Field of View = 101.7 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S21 | 999.37 | 0.70 | 1.62 | 60 | −7.657 | L21 |
| S22 | 4.74 | 1.94 | | | | |
| S23 | 39.81 | 1.63 | 2.00 | 16 | 34.417 | L22 |
| S24 | −270.85 | 1.01 | | | | |
| S25 | ∞ | 0.20 | | | | ST2 |
| S26 | 15.02 | 2.80 | 1.50 | 60 | 17.580 | L23 |
| S27 | −20.02 | 1.29 | | | | |
| S28 | −11.89 | 0.73 | 1.60 | 20 | −17.344 | L24 |
| S29 | 92.23 | 0.33 | | | | |
| S210 | 74.43 | 3.38 | 1.55 | 80 | 14.917 | L25 |
| S211 | −9.10 | 0.06 | | | | |
| S212 | 31.05 | 3.32 | 1.62 | 64 | 19.000 | L26 |
| S213 | −18.29 | 2.20 | | | | |
| S214 | 12.80 | 5.00 | 1.62 | 64 | 17.111 | L27 |
| S215 | −53.69 | 1.37 | | | | |
| S216 | −15.57 | 1.40 | 1.66 | 20 | −14.891 | L28 |
| S217 | 28.28 | 2.64 | | | | |

In the second embodiment, the conic constant k and the aspheric

coefficients A, B, C, D of each aspheric lens are shown in Table 5.

TABLE 5

| Surface | | | | | |
|---|---|---|---|---|---|
| Number | k | A | B | C | D |
| S26 | −3.13E+00 | 7.05E−04 | 4.13E−05 | −1.55E−06 | 9.41E−08 |
| S27 | −1.36E+02 | −1.27E−03 | 1.75E−04 | −1.04E−05 | 3.69E−07 |
| S212 | 2.93E+00 | 1.22E−04 | −2.36E−05 | 1.03E−06 | −2.43E−08 |
| S213 | 0.00E+00 | 9.21E−06 | −7.18E−06 | 4.35E−07 | −8.21E−09 |
| S216 | −7.08E+00 | −1.81E−04 | −1.41E−07 | 6.68E−09 | 0.00E+00 |
| S217 | 0.00E+00 | 3.21E−04 | −1.97E−06 | −3.70E−08 | −6.74E−10 |

Table 6 shows the parameters and condition values for conditions (1)-(10) in accordance with the second embodiment of the invention. It can be seen from Table 6 that the wide-angle lens assembly 2 of the second embodiment satisfies the conditions (1)-(10).

TABLE 6

| | | | | | | | |
|---|---|---|---|---|---|---|---|
| T1 | 0.70 | mm | T2 | 1.63 mm | T3 | 2.80 | mm |

| | | | | |
|---|---|---|---|---|
| T12 | 1.94 | mm | T34 | 1.29 mm |

| | | | | | | |
|---|---|---|---|---|---|---|
| Vd7/(f8/f4) | 26.09 | (R51 − R22)/Vd7 | 5.40 mm | (Vd2 − Vd6)/R22 | 0.18 | mm⁻¹ |

| | | | | | | |
|---|---|---|---|---|---|---|
| R22/Vd2 | −16.93 | mm | f8 − f4 | 2.45 mm | R32/T3 | −7.14 |

| (R31 + R32)/T3 | −1.78 | T1 + T2 + T3 | 5.13 mm | TTL/T12 | 15.43 |
|---|---|---|---|---|---|
| TTL/T34 | 23.24 | | | | |

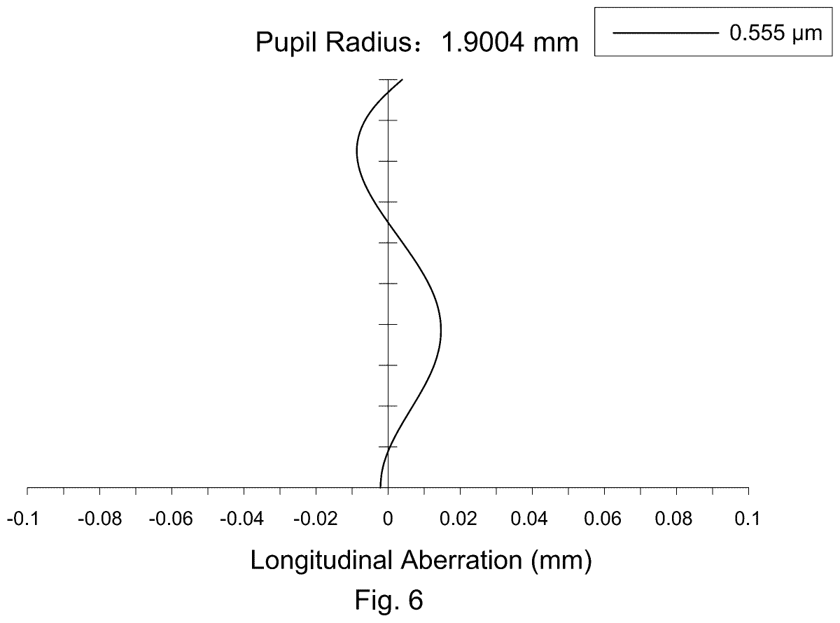

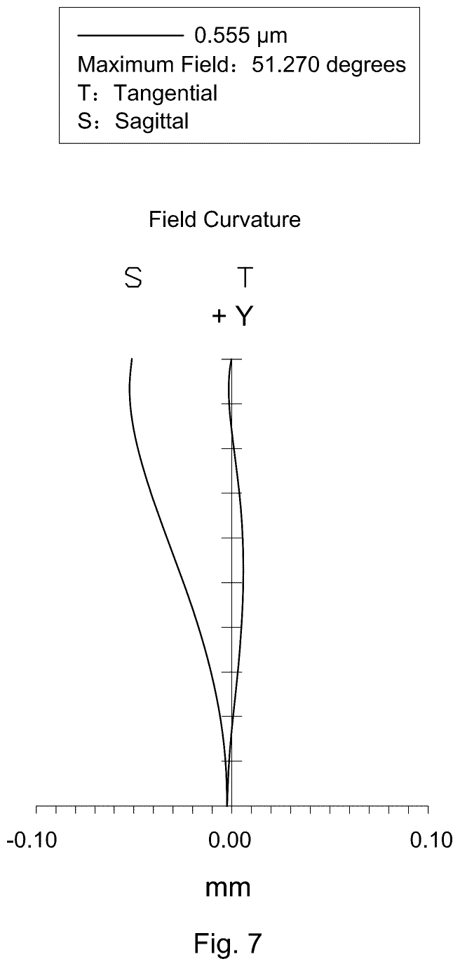

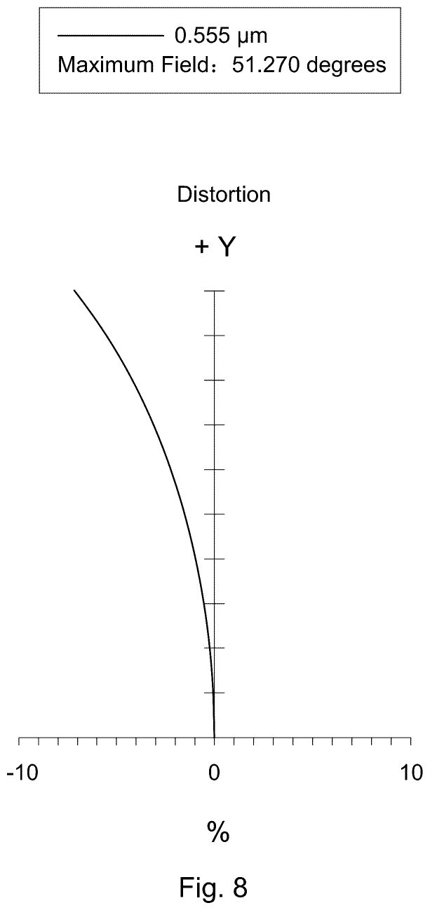

In addition, the wide-angle lens assembly 2 of the second embodiment can meet the requirements of optical performance as seen in FIGS. 6-8. It can be seen from FIG. 6 that the longitudinal aberration in the wide-angle lens assembly 2 of the second embodiment ranges from −0.01 mm to 0.02 mm. It can be seen from FIG. 7 that the field curvature of tangential direction and sagittal direction in the wide-angle lens assembly 2 of the second embodiment ranges from −0.06 mm to 0.01 mm. It can be seen from FIG. 8 that the distortion in the wide-angle lens assembly 2 of the second embodiment ranges from −7% to 0%. It is obvious that the longitudinal aberration, the field curvature, and the distortion of the wide-angle lens assembly 2 of the second embodiment can be corrected effectively. Therefore, the wide-angle lens assembly 2 of the second embodiment is capable of good optical performance.

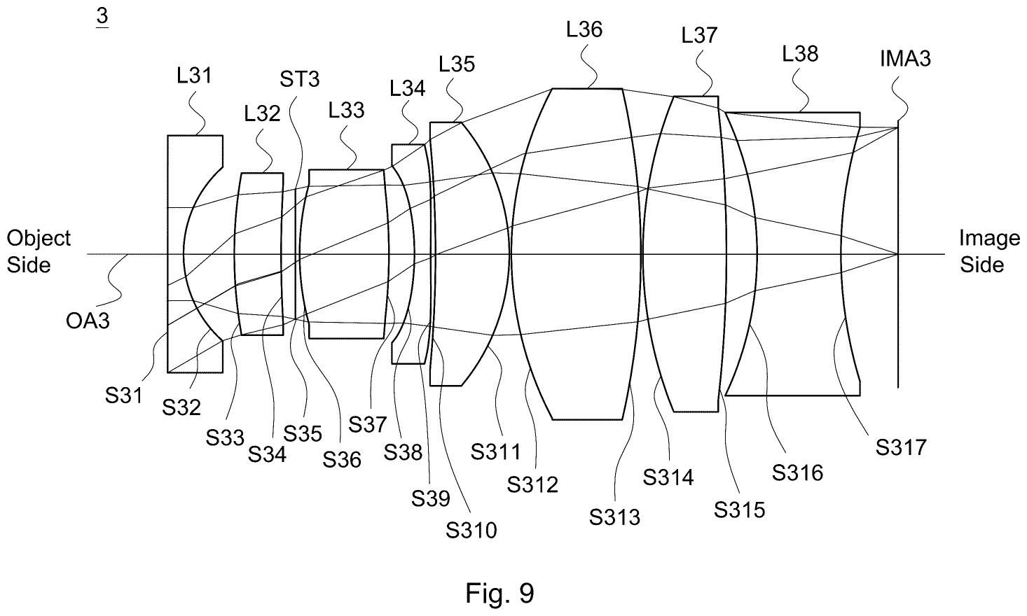

A detailed description of a wide-angle lens assembly in accordance with a third embodiment of the invention is as follows. Referring to FIG. 9, the wide-angle lens assembly 3 includes a first lens L31, a second lens L32, a stop ST3, a third lens L33, a fourth lens L34, a fifth lens L35, a sixth lens L36, a seventh lens L37, and an eighth lens L38, all of which are arranged in order from an object side to an image side along an optical axis OA3. In operation, the light from the object side is imaged on an image plane IMA3.

According to the foregoing, wherein: the first lens L31 is a meniscus lens, wherein the object side surface S31 is a convex surface; the second lens L32 is a meniscus lens, wherein the image side surface S34 is a concave surface; the fifth lens L35 is a meniscus lens, wherein the object side surface S310 is a concave surface; with the above design of the lenses, stop ST3, and at least one of the conditions (1)-(10) satisfied, the wide-angle lens assembly 3 can have an effective decreased total lens length, an effective decreased F-number, an effective increased resolution, and an effective corrected aberration. The wide-angle lens assembly of the present invention can meet the basic operation requirements when it only satisfies conditions (6), (7), or (8), and the refractive surface shape characteristics of the independent claim.

Table 7 shows the optical specification of the wide-angle lens assembly 3 in FIG. 9.

TABLE 7
Effective Focal Length = 6.1986 mm F-number = 1.64
Total Lens Length = 30.00 mm Field of View = 101.7 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S31 | 299.05 | 0.70 | 1.60 | 60 | −8.008 | L31 |
| S32 | 4.74 | 2.07 | | | | |
| S33 | 18.67 | 1.92 | 2.00 | 16 | 28.918 | L32 |
| S34 | 48.95 | 0.59 | | | | |
| S35 | ∞ | 0.17 | | | | ST3 |
| S36 | 13.08 | 3.67 | 1.50 | 60 | 15.753 | L33 |
| S37 | −18.08 | 1.04 | | | | |
| S38 | −10.79 | 0.67 | 1.60 | 20 | −16.201 | L34 |
| S39 | 110.82 | 0.19 | | | | |
| S310 | −51.04 | 3.05 | 1.60 | 70 | 15.964 | L35 |
| S311 | −8.26 | 0.06 | | | | |
| S312 | 14.47 | 5.35 | 1.60 | 70 | 16.826 | L36 |
| S313 | −29.04 | 0.06 | | | | |
| S314 | 17.12 | 3.42 | 1.80 | 50 | 16.529 | L37 |
| S315 | −53.79 | 1.23 | | | | |
| S316 | −17.23 | 3.44 | 1.60 | 20 | −13.674 | L38 |
| S317 | 17.14 | 2.37 | | | | |

In the third embodiment, the conic constant k and the aspheric coefficients A, B, C, D of each aspheric lens are shown in Table 8.

TABLE 8

| Surface | | | | | |
|---|---|---|---|---|---|
| Number | k | A | B | C | D |
| S36 | 1.47E+00 | 5.78E−04 | 6.54E−05 | −4.64E−06 | 2.42E−07 |
| S37 | −8.19E+01 | −7.11E−04 | 1.06E−04 | −5.59E−06 | 1.51E−07 |
| S312 | 6.17E+00 | −2.82E−04 | −2.15E−05 | 2.11E−06 | −1.10E−07 |
| S313 | 0.00E+00 | −9.61E−04 | 1.19E−05 | −3.20E−07 | −1.08E−09 |
| S316 | 2.55E+00 | −2.33E−04 | −3.18E−08 | 6.14E−08 | 0.00E+00 |
| S317 | 0.00E+00 | 9.40E−05 | −6.04E−06 | 1.36E−07 | −1.16E−09 |

Table 9 shows the parameters and condition values for conditions (1)-(10) in accordance with the third embodiment of the invention. It can be seen from Table 9 that the wide-angle lens assembly 3 of the third embodiment satisfies the conditions (1)-(10).

TABLE 9

| T1 | 0.70 mm | T2 | 1.92 | mm | T3 | 3.67 | mm |
|---|---|---|---|---|---|---|---|
| T12 | 2.07 mm | T34 | 1.04 | mm | | | |
| Vd7/(f8/f4) | 19.79 | (R51 − R22)/Vd7 | −2.00 | mm | (Vd2 − Vd6)/R22 | −1.10 | mm⁻¹ |

| | | | | | | |
|---|---|---|---|---|---|---|
| R22/Vd2 | 3.06 mm | f8 − f4 | 2.53 | mm | R32/T3 | −4.93 |
| (R31 + R32)/T3 | −1.36 | T1 + T2 + T3 | 6.29 | mm | TTL/T12 | 14.49 |

| | |
|---|---|
| TTL/T34 | 28.82 |

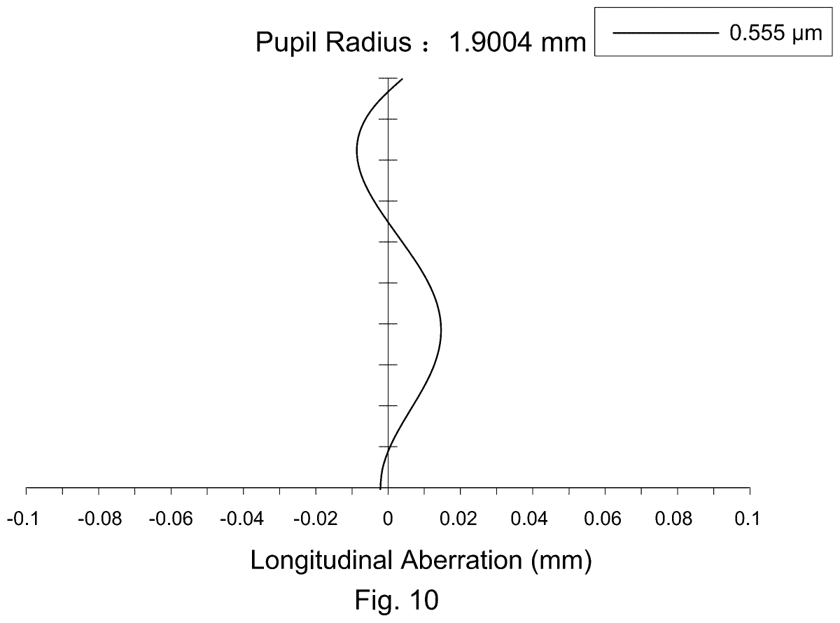

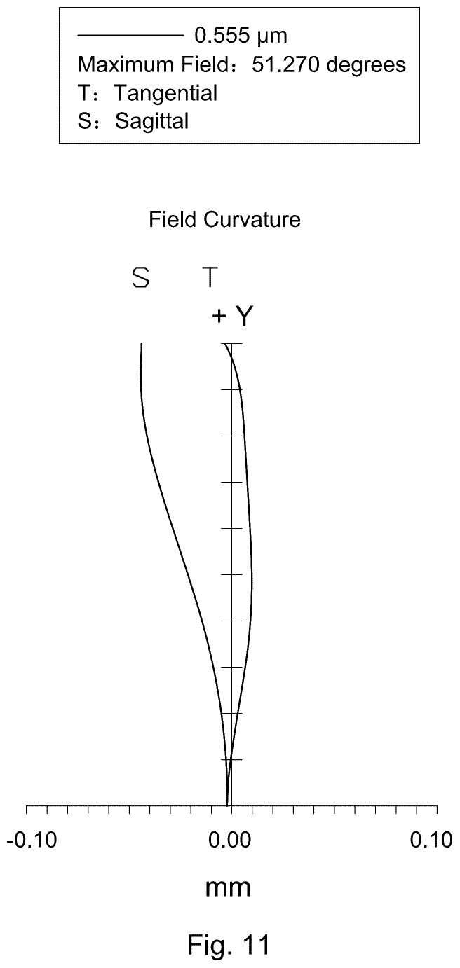

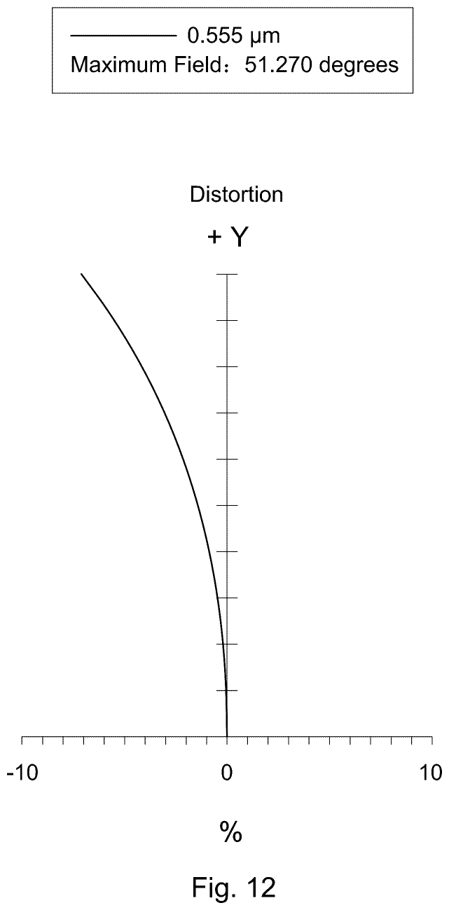

In addition, the wide-angle lens assembly 3 of the third embodiment can meet the requirements of optical performance as seen in FIGS. 10-12. It can be seen from FIG. 10 that the longitudinal aberration in the wide-angle lens assembly 3 of the third embodiment ranges from −0.01 mm to 0.02 mm. It can be seen from FIG. 11 that the field curvature of tangential direction and sagittal direction in the wide-angle lens assembly 3 of the third embodiment ranges from −0.05 mm to 0.01 mm. It can be seen from FIG. 12 that the distortion in the wide-angle lens assembly 3 of the third embodiment ranges from −7% to 0%. It is obvious that the longitudinal aberration, the field curvature, and the distortion of the wide-angle lens assembly 3 of the third embodiment can be corrected effectively. Therefore, the wide-angle lens assembly 3 of the third embodiment is capable of good optical performance.

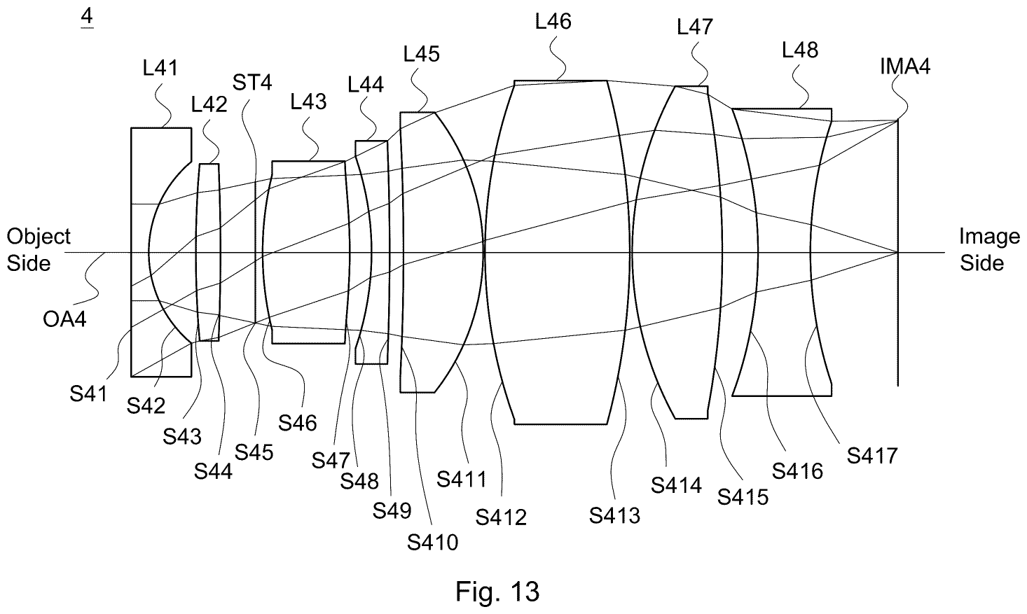

A detailed description of a wide-angle lens assembly in accordance with a fourth embodiment of the invention is as follows. Referring to FIG. 13, the wide-angle lens assembly 4 includes a first lens L41, a second lens L42, a stop ST4, a third lens L43, a fourth lens L44, a fifth lens L45, a sixth lens L46, a seventh lens L47, and an eighth lens L48, all of which are arranged in order from an object side to an image side along an optical axis OA4. In operation, the light from the object side is imaged on an image plane IMA4.

According to the foregoing, wherein: the first lens L41 is a meniscus lens, wherein the object side surface S41 is a convex surface; the second lens L42 is a biconvex lens, wherein the image side surface S44 is a convex surface; the fifth lens L45 is a meniscus lens, wherein the object side surface S410 is a concave surface; with the above design of the lenses, stop ST4, and at least one of the conditions (1)-(10) satisfied, the wide-angle lens assembly 4 can have an effective decreased total lens length, an effective decreased F-number, an effective increased resolution, and an effective corrected aberration. The wide-angle lens assembly of the present invention can meet the basic operation requirements when it only satisfies conditions (9) or (10), and the refractive surface shape characteristics of the independent claim.

Table 10 shows the optical specification of the wide-angle lens assembly 4 in FIG. 13.

TABLE 10
Effective Focal Length = 6.231 mm F-number = 1.64
Total Lens Length = 30.00 mm Field of View = 101.7 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S41 | 9908.93 | 0.70 | 1.60 | 70 | −7.759 | L41 |
| S42 | 4.67 | 1.84 | | | | |
| S43 | 44.09 | 0.95 | 1.85 | 24 | 33.426 | L42 |
| S44 | −80.80 | 1.36 | | | | |
| S45 | ∞ | 0.29 | | | | ST4 |
| S46 | 15.24 | 3.41 | 1.50 | 60 | 18.547 | L43 |
| S47 | −22.10 | 0.84 | | | | |
| S48 | −13.96 | 0.71 | 1.65 | 20 | −21.245 | L44 |
| S49 | 8844.17 | 0.54 | | | | |
| S410 | −102.30 | 3.13 | 1.60 | 70 | 15.974 | L45 |
| S411 | −8.89 | 0.06 | | | | |
| S412 | 19.19 | 5.70 | 1.60 | 70 | 19.004 | L46 |
| S413 | −25.13 | 0.06 | | | | |
| S414 | 13.47 | 3.53 | 1.60 | 70 | 16.585 | L47 |
| S415 | −34.73 | 1.42 | | | | |
| S416 | −18.43 | 2.03 | 1.65 | 20 | −13.502 | L48 |
| S417 | 17.79 | 3.43 | | | | |

In the fourth embodiment, the conic constant k and the aspheric coefficients A, B, C, D of each aspheric lens are shown in Table 11.

TABLE 11

| Surface | | | | | |
|---|---|---|---|---|---|
| Number | k | A | B | C | D |
| S46 | −9.01E−01 | 4.48E−04 | 4.70E−05 | −2.38E−06 | 8.96E−08 |
| S47 | −1.17E+02 | −6.61E−04 | 5.51E−05 | 2.93E−07 | −2.98E−08 |
| S412 | 8.66E+00 | 3.81E−05 | −1.02E−05 | 2.50E−06 | −5.84E−08 |
| S413 | 0.00E+00 | −3.39E−04 | 1.01E−05 | −5.29E−08 | −7.72E−09 |
| S416 | −1.35E+00 | −2.71E−04 | 4.32E−06 | −3.83E−08 | 0.00E+00 |
| S417 | 0.00E+00 | 8.19E−05 | 4.51E−07 | 6.52E−08 | −2.50E−09 |

Table 12 shows the parameters and condition values for conditions (1)-(10) in accordance with the fourth embodiment of the invention. It can be seen from Table 12 that the wide-angle lens assembly 4 of the fourth embodiment satisfies the conditions (1)-(10).

TABLE 12

| | | | | | | | | |
|---|---|---|---|---|---|---|---|---|
| T1 | 0.70 | mm | T2 | 0.95 | mm | T3 | 3.41 | mm |

| | | | | | |
|---|---|---|---|---|---|
| T12 | 1.84 | mm | T34 | 0.84 | mm |

| | | | | | | | |
|---|---|---|---|---|---|---|---|
| Vd7/(f8/f4) | 9.04 | (R51 − R22)/Vd7 | −0.31 | mm | (Vd2 − Vd6)/R22 | 0.57 | mm⁻¹ |

| | | | | | | | |
|---|---|---|---|---|---|---|---|
| R22/Vd2 | −3.37 | mm | f8 − f4 | 7.74 | mm | R32/T3 | −6.49 |

| | | | | | | |
|---|---|---|---|---|---|---|
| (R31 + R32)/T3 | −2.01 | T1 + T2 + T3 | 5.06 | mm | TTL/T12 | 16.30 |

| | |
|---|---|
| TTL/T34 | 35.84 |

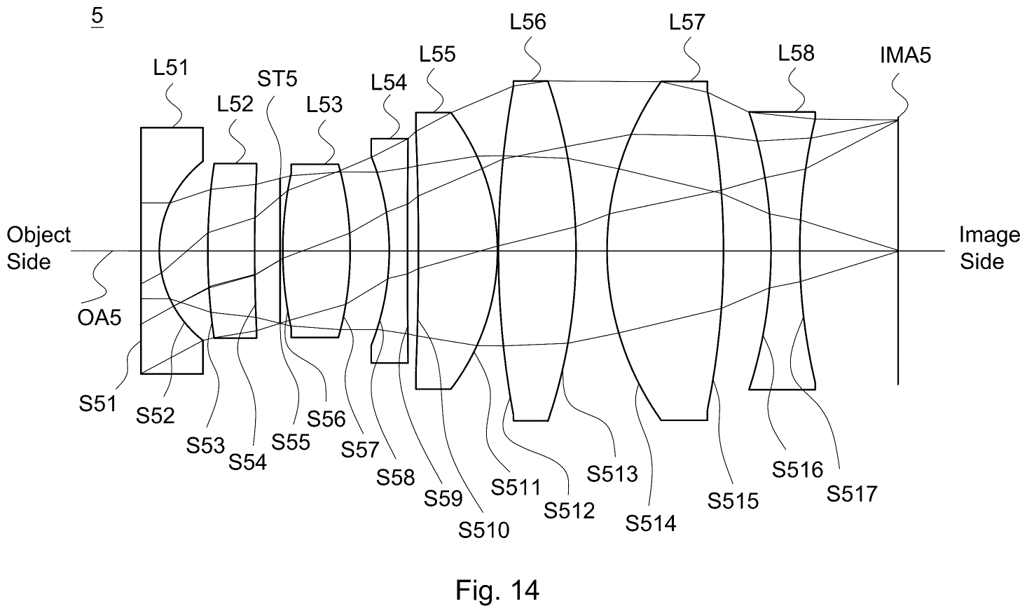

A detailed description of a wide-angle lens assembly in accordance with a fifth embodiment of the invention is as follows. Referring to FIG. 14, the wide-angle lens assembly 5 includes a first lens L51, a second lens L52, a stop ST5, a third lens L53, a fourth lens L54, a fifth lens L55, a sixth lens L56, a seventh lens L57, and an eighth lens L58, all of which are arranged in order from an object side to an image side along an optical axis OA5. In operation, the light from the object side is imaged on an image plane IMA5.

According to the foregoing, wherein: the first lens L51 is a biconcave lens, wherein the object side surface S51 is a concave surface; the second lens L52 is a meniscus lens, wherein the image side surface S54 is a concave surface; the fifth lens L55 is a meniscus lens, wherein the object side surface S510 is a concave surface; with the above design of the lenses, stop ST5, and at least one of the conditions (1)-(10) satisfied, the wide-angle lens assembly 5 can have an effective decreased total lens length, an effective decreased F-number, an effective increased resolution, and an effective corrected aberration.

Table 13 shows the optical specification of the wide-angle lens assembly 5 in FIG. 14.

TABLE 13
Effective Focal Length = 6.1986 mm F-number = 1.64
Total Lens Length = 29.93 mm Field of View = 101.7 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S51 | −468.32 | 0.70 | 1.62 | 60 | −7.202 | L51 |
| S52 | 4.53 | 1.93 | | | | |
| S53 | 25.57 | 1.85 | 2.00 | 16 | 36.801 | L52 |
| S54 | 78.73 | 0.99 | | | | |
| S55 | ∞ | 0.11 | | | | ST5 |
| S56 | 18.16 | 2.66 | 1.50 | 60 | 14.442 | L53 |
| S57 | −11.46 | 1.57 | | | | |
| S58 | −11.42 | 0.69 | 1.65 | 20 | −15.585 | L54 |
| S59 | 100.07 | 0.46 | | | | |
| S510 | −90.76 | 3.10 | 1.55 | 75 | 18.075 | L55 |
| S511 | −9.09 | 0.04 | | | | |
| S512 | 36.30 | 3.07 | 1.75 | 50 | 18.089 | L56 |
| S513 | −21.00 | 1.26 | | | | |
| S514 | 11.80 | 4.58 | 1.50 | 90 | 17.731 | L57 |
| S515 | −31.29 | 1.86 | | | | |
| S516 | −20.05 | 1.16 | 1.65 | 20 | −18.618 | L58 |
| S517 | 31.93 | 3.91 | | | | |

In the fifth embodiment, the conic constant k and the aspheric coefficients A, B, C, D of each aspheric lens are shown in Table 14.

TABLE 14

| Surface | | | | | |
|---|---|---|---|---|---|
| Number | k | A | B | C | D |
| S56 | −5.80E−01 | 4.52E−04 | 1.96E−05 | 1.22E−06 | −2.29E−08 |
| S57 | −2.48E+01 | −1.52E−03 | 1.12E−04 | −5.86E−06 | 2.13E−07 |
| S512 | 5.25E+00 | 3.42E−04 | −1.62E−05 | −2.07E−07 | 5.48E−08 |
| S513 | 0.00E+00 | −7.56E−05 | −1.70E−05 | 8.37E−07 | −1.35E−08 |
| S516 | 7.18E+00 | 1.35E−04 | −5.64E−06 | 1.36E−07 | 0.00E+00 |
| S517 | 0.00E+00 | 3.79E−04 | −7.43E−06 | 8.58E−08 | −5.80E−10 |

Table 15 shows the parameters and condition values for conditions (1)-(10) in accordance with the fifth embodiment of the invention. It can be seen from Table 15 that the wide-angle lens assembly 5 of the fifth embodiment satisfies the conditions (1)-(10).

TABLE 15

| T1 | 0.70 mm | T2 | 1.85 | mm | T3 | 2.66 | mm |
|---|---|---|---|---|---|---|---|
| T12 | 1.93 mm | T34 | 1.57 | mm | | | |
| Vd7/(f8/f4) | −29.67 | (R51 − R22)/Vd7 | −1.88 | mm | (Vd2 − Vd6)/R22 | −0.43 | mm⁻¹ |

| | | | | | | |
|---|---|---|---|---|---|---|
| R22/Vd2 | 4.92 mm | f8 − f4 | −3.03 | mm | R32/T3 | −4.31 |
| (R31 + R32)/T3 | 2.52 | T1 + T2 + T3 | 5.21 | mm | TTL/T12 | 15.52 |

| | |
|---|---|
| TTL/T34 | 19.07 |

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A wide-angle lens assembly comprising:
a first lens which is with refractive power;
a second lens which is with refractive power;
a third lens which is with positive refractive power and comprises a convex surface facing an image side;
a fourth lens which is with refractive power;
a fifth lens which is with positive refractive power and comprises a convex surface facing the image side;
a sixth lens which is with refractive power;
a seventh lens which is with positive refractive power; and
an eighth lens which is with refractive and comprises a concave surface facing an object side;
wherein the first lens, the second lens, the third lens, the fourth lens, the fifth lens, the sixth lens, the seventh lens, and the eighth lens are arranged in order from the object side to the image side along an optical axis.

2. The wide-angle lens assembly as claimed in claim 1, wherein:
the first lens is with negative refractive power;
the second lens is with positive refractive power;
the fourth lens is with negative refractive power;
the sixth lens is with positive refractive power; and
the eighth lens is with negative refractive power.

3. The wide-angle lens assembly as claimed in claim 2, wherein:
the first lens comprises a concave surface facing the image side;
the second lens comprises a convex surface facing the object side;
the third lens is a biconvex lens and further comprises another convex surface facing the object side; and
the eighth lens is a biconcave lens and further comprises another concave surface facing the image side.

4. The wide-angle lens assembly as claimed in claim 3, wherein:
the first lens is a meniscus lens and further comprises a convex surface facing the object side; and
the second lens is a meniscus lens and further comprises a concave surface facing the image side.

5. The wide-angle lens assembly as claimed in claim 4, wherein the wide-angle lens assembly satisfies at least one of following conditions:
$$- 245 \leq Vd 7 / ( f 8 / f 4 ) \leq 27 ;$$
$$- 3 mm \leq ( R 51 - R 22 ) / Vd 7 \leq 41 mm ;$$
$$- 1.2 {mm}^{- 1} \leq ( Vd 2 - Vd 6 ) / R 22 \leq 0.7 {mm}^{- 1} ;$$
$$- 17 mm \leq R 22 / Vd 2 \leq 6.2 mm ;$$
$$- 3.1 mm \leq f 8 - f 4 \leq 7.8 mm ;$$
$$- 7.29 \leq R 32 / T 3 \leq - 4 \text{.16} ;$$
$$- 2.24 \leq ( R 31 + R 32 ) / T 3 \leq 2 \text{.75} ;$$
$$4.92 mm \leq T 1 + T 2 + T 3 \leq 7.95 mm ;$$
$$14.32 \leq TTL / T 12 \leq 18 \text{.01} ;$$
$$18.23 \leq TTL / T 34 \leq 36 \text{.68} ;$$
wherein f4 is an effective focal length of the fourth lens, f8 is an effective focal length of the eighth lens, Vd2 is an Abbe number of the second lens, Vd6 is an Abbe number of the sixth lens, Vd7 is an Abbe number of the seventh lens, TTL is an interval from an object side surface of the first lens to an image plane along the optical axis, R22 is a radius of curvature of an image side surface of the second lens, R31 is a radius of curvature of an object side surface of the third lens, R32 is a radius of curvature of an image side surface of the third lens, R51 is a radius of curvature of an object side surface of the fifth lens, T12 is an air interval from an image side surface of the first lens to an object side surface of the second lens along the optical axis, T34 is an air interval from the image side surface of the third lens to an object side surface of the fourth lens along the optical axis, T1 is an interval from the object side surface of the first lens to the image side surface of the first lens along the optical axis, T2 is an interval from the object side surface of the second lens to the image side surface of the second lens along the optical axis, and T3 is an interval from the object side surface of the third lens to the image side surface of the third lens along the optical axis.

6. The wide-angle lens assembly as claimed in claim 3, wherein:
the first lens is a meniscus lens and further comprises a convex surface facing the object side; and
the second lens is a biconvex lens and further comprises another convex surface facing the image side.

7. The wide-angle lens assembly as claimed in claim 6, wherein the wide-angle lens assembly satisfies at least one of following conditions:
$$- 245 \leq Vd 7 / ( f 8 / f 4 ) \leq 27 ;$$
$$- 3 mm \leq ( R 51 - R 22 ) / Vd 7 \leq 41 mm ;$$
$$- 1.2 {mm}^{- 1} \leq ( Vd 2 - Vd 6 ) / R 22 \leq 0.7 {mm}^{- 1} ;$$
$$- 17 mm \leq R 22 / Vd 2 \leq 6.2 mm ;$$
$$- 3.1 mm \leq f 8 - f 4 \leq 7.8 mm ;$$
$$- 7.29 \leq R 32 / T 3 \leq - 4 \text{.16} ;$$
$$- 2.24 \leq ( R 31 + R 32 ) / T 3 \leq 2 \text{.75} ;$$
$$4.92 mm \leq T 1 + T 2 + T 3 \leq 7.95 mm ;$$
$$14.32 \leq TTL / T 12 \leq 18 \text{.01} ;$$
$$18.23 \leq TTL / T 34 \leq 36 \text{.68} ;$$
wherein f4 is an effective focal length of the fourth lens, f8 is an effective focal length of the eighth lens, Vd2 is an Abbe number of the second lens, Vd6 is an Abbe number of the sixth lens, Vd7 is an Abbe number of the seventh lens, TTL is an interval from an object side surface of the first lens to an image plane along the optical axis, R22 is a radius of curvature of an image side surface of the second lens, R31 is a radius of curvature of an object side surface of the third lens, R32 is a radius of curvature of an image side surface of the third lens, R51 is a radius of curvature of an object side surface of the fifth lens, T12 is an air interval from an image side surface of the first lens to an object side surface of the second lens along the optical axis, T34 is an air interval from the image side surface of the third lens to an object side surface of the fourth lens along the optical axis, T1 is an interval from the object side surface of the first lens to the image side surface of the first lens along the optical axis, T2 is an interval from the object side surface of the second lens to the image side surface of the second lens along the optical axis, and T3 is an interval from the object side surface of the third lens to the image side surface of the third lens along the optical axis.

8. The wide-angle lens assembly as claimed in claim 3, wherein:
the first lens is a biconcave lens and further comprises another concave surface facing the object side; and
the second lens is a meniscus lens and further comprises a concave surface facing the image side.

9. The wide-angle lens assembly as claimed in claim 8, wherein the wide-angle lens assembly satisfies at least one of following conditions:
$$- 245 \leq Vd 7 / ( f 8 / f 4 ) \leq 27 ;$$
$$- 3 mm \leq ( R 51 - R 22 ) / Vd 7 \leq 41 mm ;$$
$$- 1.2 {mm}^{- 1} \leq ( Vd 2 - Vd 6 ) / R 22 \leq 0.7 {mm}^{- 1} ;$$
$$- 17 mm \leq R 22 / Vd 2 \leq 6.2 mm ;$$
$$- 3.1 mm \leq f 8 - f 4 \leq 7.8 mm ;$$
$$- 7.29 \leq R 32 / T 3 \leq - 4 \text{.16} ;$$
$$- 2.24 \leq ( R 31 + R 32 ) / T 3 \leq 2 \text{.75} ;$$
$$4.92 mm \leq T 1 + T 2 + T 3 \leq 7.95 mm ;$$
$$14.32 \leq TTL / T 12 \leq 18 \text{.01} ;$$
$$18.23 \leq TTL / T 34 \leq 36 \text{.68} ;$$
wherein f4 is an effective focal length of the fourth lens, f8 is an effective focal length of the eighth lens, Vd2 is an Abbe number of the second lens, Vd6 is an Abbe number of the sixth lens, Vd7 is an Abbe number of the seventh lens, TTL is an interval from an object side surface of the first lens to an image plane along the optical axis, R22 is a radius of curvature of an image side surface of the second lens, R31 is a radius of curvature of an object side surface of the third lens, R32 is a radius of curvature of an image side surface of the third lens, R51 is a radius of curvature of an object side surface of the fifth lens, T12 is an air interval from an image side surface of the first lens to an object side surface of the second lens along the optical axis, T34 is an air interval from the image side surface of the third lens to an object side surface of the fourth lens along the optical axis, T1 is an interval from the object side surface of the first lens to the image side surface of the first lens along the optical axis, T2 is an interval from the object side surface of the second lens to the image side surface of the second lens along the optical axis, and T3 is an interval from the object side surface of the third lens to the image side surface of the third lens along the optical axis.

10. The wide-angle lens assembly as claimed in claim 2, wherein:
the fourth lens is a biconcave lens and comprises a concave surface facing the object side and another concave surface facing the image side;
the sixth lens is a biconvex lens and comprises a convex surface facing the object side and another convex surface facing the image side; and
the seventh lens is a biconvex lens and comprises a convex surface facing the object side and another convex surface facing the image side.

11. The wide-angle lens assembly as claimed in claim 10, wherein the fifth lens is a biconvex lens and further comprises another convex surface facing the object side.

12. The wide-angle lens assembly as claimed in claim 11, wherein the wide-angle lens assembly satisfies at least one of following conditions:
$$- 245 \leq Vd 7 / ( f 8 / f 4 ) \leq 27 ;$$
$$- 3 mm \leq ( R 51 - R 22 ) / Vd 7 \leq 41 mm ;$$
$$- 1.2 {mm}^{- 1} \leq ( Vd 2 - Vd 6 ) / R 22 \leq 0.7 {mm}^{- 1} ;$$
$$- 17 mm \leq R 22 / Vd 2 \leq 6.2 mm ;$$
$$- 3.1 mm \leq f 8 - f 4 \leq 7.8 mm ;$$
$$- 7.29 \leq R 32 / T 3 \leq - 4 \text{.16} ;$$
$$- 2.24 \leq ( R 31 + R 32 ) / T 3 \leq 2 \text{.75} ;$$
$$4.92 mm \leq T 1 + T 2 + T 3 \leq 7.95 mm ;$$
$$14.32 \leq TTL / T 12 \leq 18 \text{.01} ;$$
$$18.23 \leq TTL / T 34 \leq 36 \text{.68} ;$$
wherein f4 is an effective focal length of the fourth lens, f8 is an effective focal length of the eighth lens, Vd2 is an Abbe number of the second lens, Vd6 is an Abbe number of the sixth lens, Vd7 is an Abbe number of the seventh lens, TTL is an interval from an object side surface of the first lens to an image plane along the optical axis, R22 is a radius of curvature of an image side surface of the second lens, R31 is a radius of curvature of an object side surface of the third lens, R32 is a radius of curvature of an image side surface of the third lens, R51 is a radius of curvature of an object side surface of the fifth lens, T12 is an air interval from an image side surface of the first lens to an object side surface of the second lens along the optical axis, T34 is an air interval from the image side surface of the third lens to an object side surface of the fourth lens along the optical axis, T1 is an interval from the object side surface of the first lens to the image side surface of the first lens along the optical axis, T2 is an interval from the object side surface of the second lens to the image side surface of the second lens along the optical axis, and T3 is an interval from the object side surface of the third lens to the image side surface of the third lens along the optical axis.

13. The wide-angle lens assembly as claimed in claim 10, wherein the fifth lens is a meniscus lens and further comprises a concave surface facing the object side.

14. The wide-angle lens assembly as claimed in claim 13, wherein the wide-angle lens assembly satisfies at least one of following conditions:
$$- 245 \leq Vd 7 / ( f 8 / f 4 ) \leq 27 ;$$
$$- 3 mm \leq ( R 51 - R 22 ) / Vd 7 \leq 41 mm ;$$
$$- 1.2 {mm}^{- 1} \leq ( Vd 2 - Vd 6 ) / R 22 \leq 0.7 {mm}^{- 1} ;$$
$$- 17 mm \leq R 22 / Vd 2 \leq 6.2 mm ;$$
$$- 3.1 mm \leq f 8 - f 4 \leq 7.8 mm ;$$
$$- 7.29 \leq R 32 / T 3 \leq - 4 \text{.16} ;$$
$$- 2.24 \leq ( R 31 + R 32 ) / T 3 \leq 2 \text{.75} ;$$
$$4.92 mm \leq T 1 + T 2 + T 3 \leq 7.95 mm ;$$
$$14.32 \leq TTL / T 12 \leq 18 \text{.01} ;$$
$$18.23 \leq TTL / T 34 \leq 36 \text{.68} ;$$
wherein f4 is an effective focal length of the fourth lens, f8 is an effective focal length of the eighth lens, Vd2 is an Abbe number of the second lens, Vd6 is an Abbe number of the sixth lens, Vd7 is an Abbe number of the seventh lens, TTL is an interval from an object side surface of the first lens to an image plane along the optical axis, R22 is a radius of curvature of an image side surface of the second lens, R31 is a radius of curvature of an object side surface of the third lens, R32 is a radius of curvature of an image side surface of the third lens, R51 is a radius of curvature of an object side surface of the fifth lens, T12 is an air interval from an image side surface of the first lens to an object side surface of the second lens along the optical axis, T34 is an air interval from the image side surface of the third lens to an object side surface of the fourth lens along the optical axis, T1 is an interval from the object side surface of the first lens to the image side surface of the first lens along the optical axis, T2 is an interval from the object side surface of the second lens to the image side surface of the second lens along the optical axis, and T3 is an interval from the object side surface of the third lens to the image side surface of the third lens along the optical axis.

15. The wide-angle lens assembly as claimed in claim 1, wherein the wide-angle lens assembly satisfies at least one of following conditions:
$$- 245 \leq Vd 7 / ( f 8 / f 4 ) \leq 27 ;$$
$$- 3 mm \leq ( R 51 - R 22 ) / Vd 7 \leq 41 mm ;$$
$$- 1.2 {mm}^{- 1} \leq ( Vd 2 - Vd 6 ) / R 22 \leq 0.7 {mm}^{- 1} ;$$
$$- 17 mm \leq R 22 / Vd 2 \leq 6.2 mm ;$$
$$- 3.1 mm \leq f 8 - f 4 \leq 7.8 mm ;$$
$$- 7.29 \leq R 32 / T 3 \leq - 4 \text{.16} ;$$
$$- 2.24 \leq ( R 31 + R 32 ) / T 3 \leq 2 \text{.75} ;$$
$$4.92 mm \leq T 1 + T 2 + T 3 \leq 7.95 mm ;$$
$$14.32 \leq TTL / T 12 \leq 18 \text{.01} ;$$
$$18.23 \leq TTL / T 34 \leq 36 \text{.68} ;$$
wherein f4 is an effective focal length of the fourth lens, f8 is an effective focal length of the eighth lens, Vd2 is an Abbe number of the second lens, Vd6 is an Abbe number of the sixth lens, Vd7 is an Abbe number of the seventh lens, TTL is an interval from an object side surface of the first lens to an image plane along the optical axis, R22 is a radius of curvature of an image side surface of the second lens, R31 is a radius of curvature of an object side surface of the third lens, R32 is a radius of curvature of an image side surface of the third lens, R51 is a radius of curvature of an object side surface of the fifth lens, T12 is an air interval from an image side surface of the first lens to an object side surface of the second lens along the optical axis, T34 is an air interval from the image side surface of the third lens to an object side surface of the fourth lens along the optical axis, T1 is an interval from the object side surface of the first lens to the image side surface of the first lens along the optical axis, T2 is an interval from the object side surface of the second lens to the image side surface of the second lens along the optical axis, and T3 is an interval from the object side surface of the third lens to the image side surface of the third lens along the optical axis.

16. The wide-angle lens assembly as claimed in claim 15, wherein:
the first lens is a meniscus lens with negative refractive power and comprises a convex surface facing the object side and a concave surface facing the image side;
the second lens is a meniscus lens with positive refractive power and comprises a convex surface facing the object side and a concave surface facing the image side;
the third lens is a biconvex lens and further comprises another convex surface facing the object side;
the fourth lens is a biconcave lens with negative refractive power and comprises a concave surface facing the object side and another concave surface facing the image side;
the fifth lens is a biconvex lens and further comprises another convex surface facing the object side;
the sixth lens is a biconvex lens with positive refractive power and comprises a convex surface facing the object side and another convex surface facing the image side;
the seventh lens is a biconvex lens and comprises a convex surface facing the object side and another convex surface facing the image side; and
the eighth lens is a biconcave lens with negative refractive power and further comprises another concave surface facing the image side.

17. The wide-angle lens assembly as claimed in claim 15, wherein:
the first lens is a meniscus lens with negative refractive power and comprises a convex surface facing the object side and a concave surface facing the image side;
the second lens is a meniscus lens with positive refractive power and comprises a convex surface facing the object side and a concave surface facing the image side;
the third lens is a biconvex lens and further comprises another convex surface facing the object side;
the fourth lens is a biconcave lens with negative refractive power and comprises a concave surface facing the object side and another concave surface facing the image side;
the fifth lens is a meniscus lens and further comprises a concave surface facing the object side;
the sixth lens is a biconvex lens with positive refractive power and comprises a convex surface facing the object side and another convex surface facing the image side;
the seventh lens is a biconvex lens and comprises a convex surface facing the object side and another convex surface facing the image side; and
the eighth lens is a biconcave lens with negative refractive power and further comprises another concave surface facing the image side.

18. The wide-angle lens assembly as claimed in claim 15, wherein:
the first lens is a meniscus lens with negative refractive power and comprises a convex surface facing the object side and a concave surface facing the image side;
the second lens is a biconvex lens with positive refractive power and comprises a convex surface facing the object side and another convex surface facing the image side;
the third lens is a biconvex lens and further comprises another convex surface facing the object side;
the fourth lens is a biconcave lens with negative refractive power and comprises a concave surface facing the object side and another concave surface facing the image side;
the fifth lens is a meniscus lens and further comprises a concave surface facing the object side;
the sixth lens is a biconvex lens with positive refractive power and comprises a convex surface facing the object side and another convex surface facing the image side;
the seventh lens is a biconvex lens and comprises a convex surface facing the object side and another convex surface facing the image side; and
the eighth lens is a biconcave lens with negative refractive power and further comprises another concave surface facing the image side.

19. The wide-angle lens assembly as claimed in claim 15, wherein:
the first lens is a meniscus lens with negative refractive power and comprises a convex surface facing the object side and a concave surface facing the image side;
the second lens is a biconvex lens with positive refractive power and comprises a convex surface facing the object side and another convex surface facing the image side;
the third lens is a biconvex lens and further comprises another convex surface facing the object side;
the fourth lens is a biconcave lens with negative refractive power and comprises a concave surface facing the object side and another concave surface facing the image side;
the fifth lens is a biconvex lens and further comprises another convex surface facing the object side;
the sixth lens is a biconvex lens with positive refractive power and comprises a convex surface facing the object side and another convex surface facing the image side;
the seventh lens is a biconvex lens and comprises a convex surface facing the object side and another convex surface facing the image side; and
the eighth lens is a biconcave lens with negative refractive power and further comprises another concave surface facing the image side.

20. The wide-angle lens assembly as claimed in claim 15, wherein:
the first lens is a biconcave lens with negative refractive power and comprises a concave surface facing the object side and another concave surface facing the image side;
the second lens is a meniscus lens with positive refractive power and comprises a convex surface facing the object side and a concave surface facing the image side;
the third lens is a biconvex lens and further comprises another convex surface facing the object side;
the fourth lens is a biconcave lens with negative refractive power and comprises a concave surface facing the object side and another concave surface facing the image side;
the fifth lens is a meniscus lens and further comprises a concave surface facing the object side;
the sixth lens is a biconvex lens with positive refractive power and comprises a convex surface facing the object side and another convex surface facing the image side;
the seventh lens is a biconvex lens and comprises a convex surface facing the object side and another convex surface facing the image side; and
the eighth lens is a biconcave lens with negative refractive power and further comprises another concave surface facing the image side.
